(19) United States
(12) Patent Application Publication
(10) Pub. No.: US 2008/0158701 A1
(43) Pub. Date: Jul. 3, 2008

(54) Extensible and pivoting mirror to aid in vehicle backing

(76) Inventor: William Joseph Hanks, Indio, CA (US)

Correspondence Address: William Joseph Hanks, 81575 Santa Clara Court, PO Box 1262, Indio, CA, 92202, US

(21) Appl. No.: 11/646,997

(22) Filed: Dec. 28, 2006

(51) Int. Cl. G02B 7/182

(52) U.S. Cl. 359/877; 359/872

(57) ABSTRACT

An enclosed mechanism having a motor driven mirror assembly 42 that when mounted in positions 104 or 105 on a vehicle 106, extends and pivots to a position (see FIG. 4), that allows the vehicle's driver to have an unencumbered field of vision 103 using a high quality mirror 50. Also included with this mechanism is a control module FIG. 6A that is wired into the vehicle's electrical system FIG. 6B, allowing the mechanism to work automatically during vehicle operation or can be operated manually for cleaning and maintenance. Guiding the moving parts are 21, 41, and 42, are integral guides 51 and 52 which are incorporated into an internal mounting plate 13 and in the front enclosure 11. Also, during this movement, a torsion spring 25 is the force that used for pivoting as a cam follower 30 that follows the inside wall of the front enclosures 11, that is designed to act as the cam surface.

### CROSS-REFERENCE TO RELATED APPLICATIONS

Not Applicable

### FEDERALLY SPONSORED RESEARCH

Not Applicable

### SEQUENCE LISTING OR PROGRAM

Not Applicable

### BACKGROUND OF THE INVENTION

1. Field of Invention

This invention relates to automotive mirrors, specifically to those that generate a field of view perpendicular to the direction of travel, when backing up.

2. Prior Art

Automotive mirrors are common on all vehicles, inside rearview mirrors and outside side mirrors of many configurations. There are mirrors that mount on the front and rear of larger commercial vehicles.

Since side mirrors, multiple side mirrors, or extendable side mirrors are limited to a field of vision that sees behind and only slightly to the side of the vehicle, their value when backing into traffic is very limited. There also, exist mirrors designed to be mounted on the rear of commercial vehicles that have the some of the functionality required.

With these rear mounted mirrors, their size, construction, and mounting configuration, and style are not suitable smaller, commercial and non-commercial vehicles. This is especially true when applied to the increased numbers of larger personal vehicles. An example of this type of larger rear mounted mirror is U.S. Pat. No. 6,273,574 to Phillips, or U.S. Pat. No. 6,883,923 to Englander.

Extensible mirrors exist in various configurations, U.S. Pat. No. 5,864,438 to Pace, U.S. Pat. Nos. 6,139,159 and 6,582,087 to Whitehead, and U.S. Pat. No. 7,114,817 to Evans, Buckingham, and Bottrill, are examples. Methods of extending the mirrors also vary, U.S. Pat. No. 5,035,495 to An, U.S. Pat. No. 6,672,727 to Lohss, and U.S. Pat. No. 7,128,430 to Fernandez.

None of the extensible mirrors address the problem of viewing traffic that is both behind and traveling perpendicular to the motion of the vehicle when backing.

3. Objects and Advantages

This invention addresses the basic problem of obtaining the desired field of vision by the configuration of the construction. The style issue is overcome by the package that the mechanism is contained.

The design of this invention allows for mounting to the vehicle side at the rear or on rear surface of the vehicle, and is to be placed on either side for viewing oncoming traffic in either direction.

The retracted mirror is totally contained in a way that has allows no access to the mirror surface or mechanism, protecting the mirror surface and the mechanism from damage when not is use.

When extended, the mirror surface is in drivers sightline and offers clear fields of view to increase vehicle safety. The mirror is extended automatically when the vehicle in placed in reverse by being wired into the backup electrical circuit. It can also be extended manually by the driver for cleaning and maintenance.

A measure of both physical and electrical protection is provided. Physical protection, by the use nature of the mechanism and the design configuration, with the electrical protection provided by the design of the on board circuitry and the vehicles overload protection.

Component maintenance and replacement are made easy by having the mechanical assembly accessible from the front. The electrical portion is also removable from the front.

All the objects and advantages will become more apparent and clearer as the description is read and the drawings viewed.

### SUMMARY

This invention is a totally enclosed, self-contained extensible mirror unit designed to improve the safety of a motor vehicle when backing up. This is accomplished by offering a field of view perpendicular to the motion of the vehicle. It is incorporated into the vehicles existing mirror and electrical system.

### DRAWINGS—FIGURES

FIG. 1 shows an isometric view of the invention's mounting service with the rear enclosures surface and mounting plate partially removed for clarity.

FIGS. 2A and 2B shows an isometric view of the inventions front with the front enclosure fully and top partially removed to show many of the mechanical components, and an exploded view of a portion of the mechanism.

FIG. 3 is an isometric front view of the unit in the extended position with the enclosures front surface and top partially removed for a comparison to FIG. 2A. This view is of the Side Mount configuration.

FIG. 4 is a horizontal cross section through the unit in the extended position showing various components and some of the wiring.

FIG. 5A and FIG. 5B is a vertical cross section showing the belt drive containment features and an enlarged, exploded view of how the enclosure halves are joined. These views are when in the retracted position.

FIGS. 6A and 6B shows the control module assembly and wiring schematic.

FIG. 7 shows the various positions of the installed invention and the sightlines that a used to gain the inherent benefits.

### DRAWING—REFERENCE NUMERALS

| | | | |
|---|---|---|---|
| 10 | Rear Enclosure | 11 | Front Enclosure |
| 12 | Mirror Housing | 13 | Mounting Plate |
| 14 | Mounting Plate Fasteners | 15 | Mounting Plate Stand Off |
| 16 | Unit Mounting Holes | 17 | Wiring Access Hole |
| 18 | Enclosure Tab Release Hole | 19 | Mounting Plate Stand Off Tip |
| 20 | Slide Bearing | 21 | Re-enforced Synchronous Belt |
| 22 | Synchronous Pulley | 23 | Flanged Pivot Bearing |
| 24 | Torsion Spring Insert | 25 | Torsion Spring |
| 26 | Retaining Clip | 27 | Torsion Spring Washer |
| 28 | Pivot Shaft | 29 | Cam Follower Fastener |
| 30 | Cam Follower | 31 | Cam Follower Shaft |
| 32 | Mirror Housing Torsion Spring Tab | 33 | Slide Bearing Torsion Spring Tab |
| 34 | Split Seal | 35 | Mirror Housing Clearance Slot |
| 40 | Mounting Plate Stand Off Tip | 41 | Re-enforced Synchronous Belt End |
| 42 | Mirror Housing Assembly | 50 | Mirror |
| 51 | Slide Bearing Guide | 52 | Synchronous Belt Guide |
| 53 | Front Enclosure Locating Tab | 54 | Rear Enclosure Locating Pocket |
| 55 | Mirror Position For Rear Mount | 56 | Mirror Position For Side Mount |
| 60 | Printed Circuit Board | 61 | Printed Circuit Board Stand Off |
| 62 | Incoming Wiring Terminal Strip | 63 | Motor Wiring Terminal Strip |
| 64 | Limit Switch Wiring Terminal | 65 | On Delay Timer Relay |
| 66 | Retract Relay | 67 | Printed Circuit Board Fastener |
| 68 | Fuse Holder | 69 | Fuse |
| 70 | Motor | 71 | Vehicle Battery |
| 72 | System Fusible Link | 73 | Manual Switch |
| 74 | Reverse Switch Contac | 75 | System Ground |
| 76 | Manual Switch Indicator Light | 77 | Extended Position Limit Switch |
| 78 | Retracted Position Limit Switch | 79 | On Delay Relay NO Contact |
| 80 | Retract NO Relay Contact | 81 | Retract Relay Coil |
| 82 | Manual Switch Relay Coil | 83 | On Delay Timer Coil |
| 84 | Manual Switch Relay NO Contact | 85 | On Delay Timer NC Contact |
| 86 | On Delay Timer NC Contact | 87 | Manual Switch Relay NC Contact |
| 88 | Manual Switch Relay | 100 | Driver Sightline To Side Mirror |
| 101 | Side Mirror | 102 | Side Mirror To Invention Sightline |
| 103 | Field Of View | 104 | Invention Side Mount Location |
| 105 | Invention Rear Mount Location | 106 | Vehicle |

### DETAILED DESCRIPTION OF THE PREFERRED EMBODIMENT OF THE INVENTION

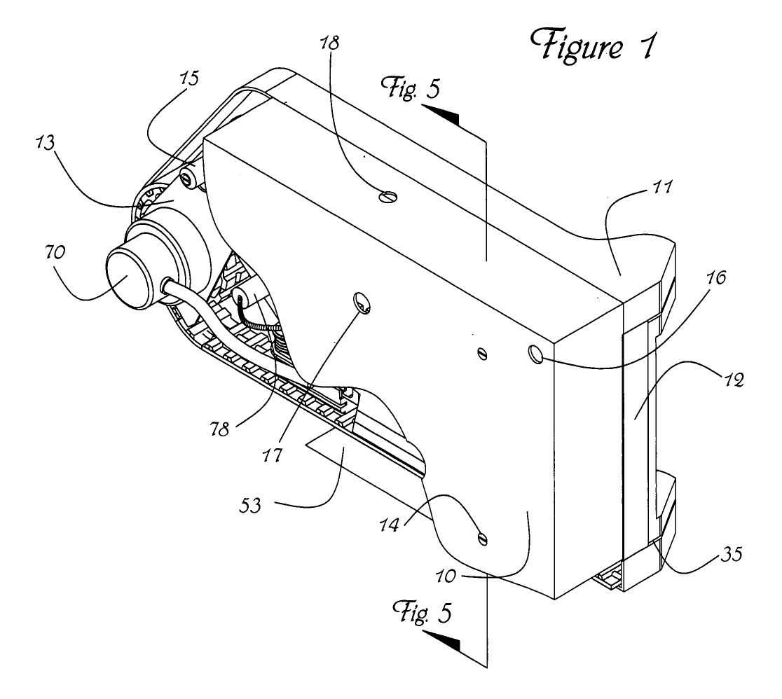

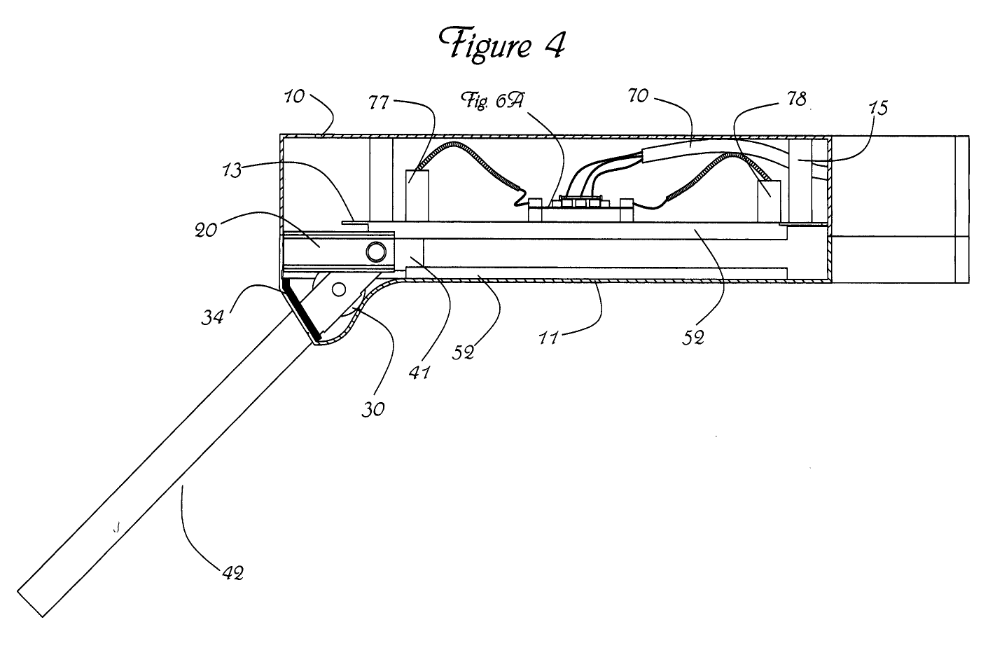

Referring first to FIG. 1, the envelope of the invention is shown in the retracted position, including the Rear Enclosure 10, Front Enclosure 11, and Mirror Housing 12. Also noted is the Mirror Housing Clearance Slot 35. When in this position, access to the inside of the invention is sealed by the Split Seal 34 (see FIG. 4) fixed to the inside wall of 11.

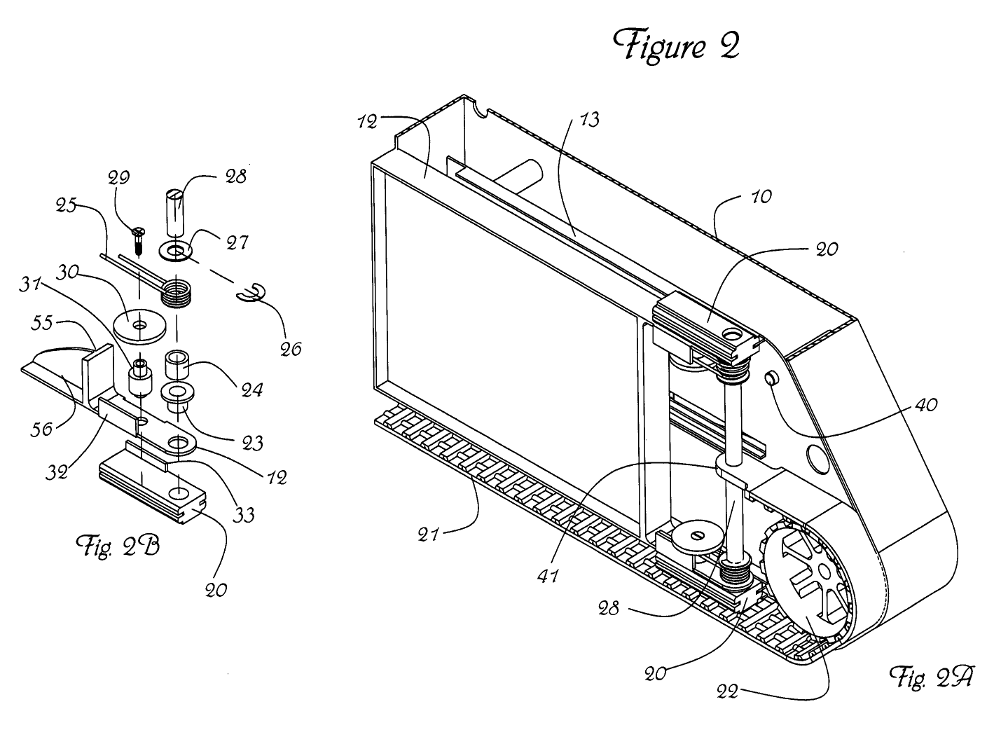

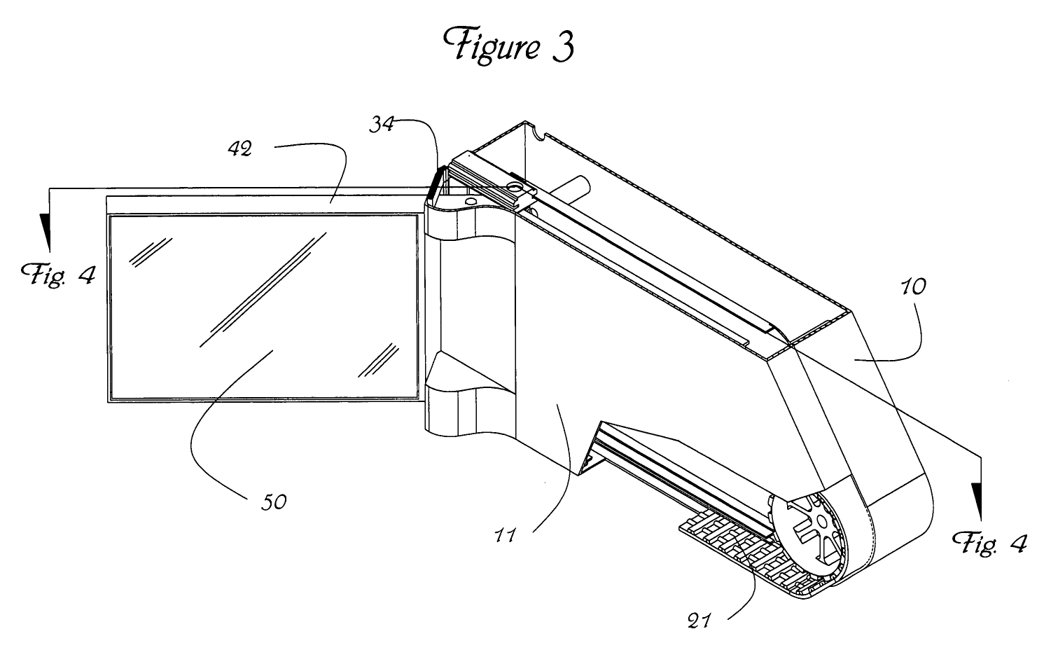

In FIG. 2 and FIG. 3, the positions of the extensible mirror are evident by the location of the Slide Bearing 20 and the position of the Mirror Housing 12. The method for moving these components are the Motor 70 (see FIG. 1), Re-enforced Synchronous Belt 21, and the Synchronous Pulley 22.

The components, shown in the lower portion, used to extend and pivot 12 to the desired position are shown in the exploded view FIG. 2B. This configuration is mirrored at the top. The Torsion Spring 25 is placed around a Torsion Spring Insert 24 that is placed between the extended leg of 12 and the Torsion Spring Washer 27, which is held in position by the Retaining Clip 26 on the Pivot Shaft 28. The Flanged Pivot Bearing 23 is pressed into 20 so the extended leg of 12 rotates on the flange of 23. As 12 is extending, the Cam Follower 30, which is attached to the Cam Follower Shaft 31, with a Cam Follower Fastener 29, and pressed into the 12, is in contact with the 11 inside wall. The shape of the 11 (see FIG. 4) is designed to act as a cam surface. The upper and lower configurations are connected by 28, which is inserted into the Flanged Pivot Bearing(s) 23 that are pressed into the upper and lower 20 with the molded Re-enforced Synchronous Belt End 41, which is integral to 21 in between. This group of components is the Mirror Housing Assembly 42 (see FIG. 4).

To pivot as 42 extends, 25 is applying pressure against the pivot able Mirror Housing Torsion Spring Tab 32 and the rigid Slide Bearing Torsion Spring Tab 33, rotating 12, when possible, as 30 follows the inside wall.

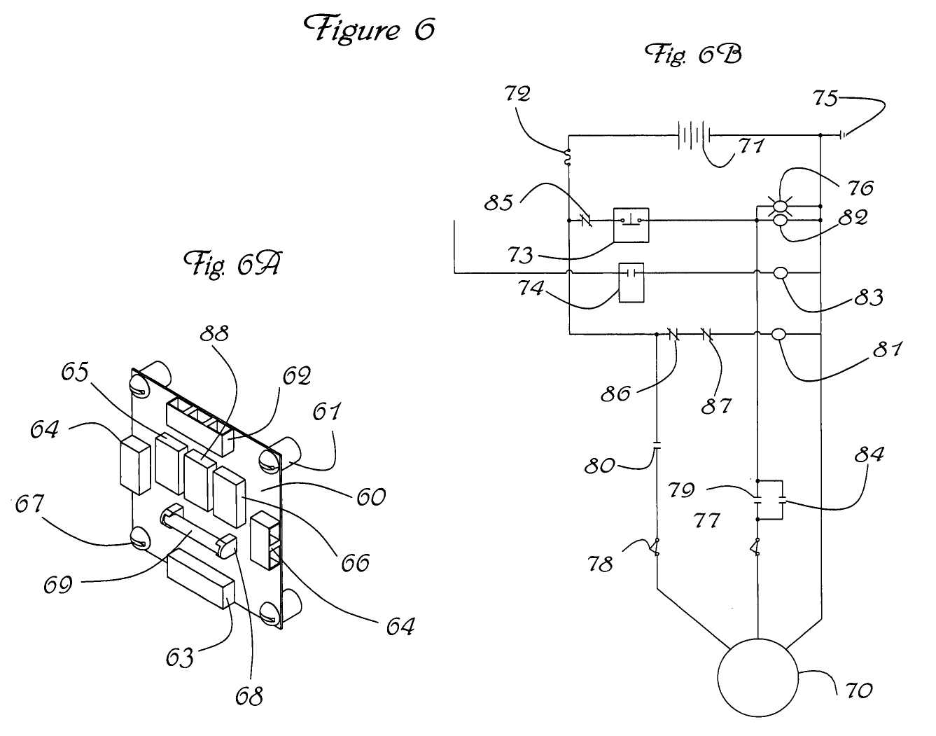

The drive control method used in this invention, consists of the Control Module FIG. 6A, the Motor 70 (see FIG. 1) and 22 (see FIGS. 1, 2A, 3, and 4). FIG. 6A consists of a Printed Circuit Board 60, with the following components soldered on to the board. Incoming Wire Terminal Strip 62, Motor Wiring Terminal Strip 63, Limit Switch Terminal Strips 64, On Delay Timer Relay 65, Retract Relay 66, Fuse Holder 68, Manual Switch Relay 89, and Fuse 69. The assembled board is mounted to the back of 13 with Printed Circuit Board Stand Off 61 and Printed Circuit Board Fasteners 67.

FIG. 6B is the electrical schematic that is the logic for FIG. 6A and how it integrates into the vehicle electrical system. The vehicle components are the Battery 71, Fusible Link 72, Reverse Switch Contact 74, and Vehicle Ground 75. To manually operate the invention, a Manual Switch 73 and Manual Switch Indicator Light 76 are installed in the operator compartment.

In the normal state of the control, power is energizing the Retract Relay Coil 81, through a Manual Switch Relay NC Contact 87 and On Delay Relay NC Contact 86. Power goes though a Retract Relay NO Contact 80, allowing 70 to turn in the retracting direction until the Retracted Position Limit Switch 78 is activated removing the power.

During manual usage 73 is switched on, lighting 76, energizing Manual Switch Relay Coil 82, closing the Manual Switch NO Contact 84, opening Manual Switch NC Contact 87, turning off the power to Retract Relay Coil 81, powering 70 in the opposite direction, moving 42 until the Extended Position Limit Switch 77 is opened stopping the motion. To retract the device in the manual mode, 73 is switched off returning the system to its normal state and position.

During normal operation of the vehicle, the invention is extended when the transmission is placed in reverse, closing a Reverse Switch Contact 74, energizing On Delay Relay Coil 83, opening On Delay Relay NC Contact 85 and 86, by-passing 73 and de-energizing 81, after a pre-determined time closing On Delay Relay NO Contact 79, powering 70 and extending 42 until 77 is contacted. When the transmission is shifted out of reverse, the system returns to the normal state.

The force generated by rotating 22 in the desired direction to extend 42, moves 21 with the molded end 41, to the extended position (see FIG. 4). The Slide Bearing(s) 20 ride on the Slide Bearing Guide(s) 51 that are integrated into the Mounting Plate 13 and the Front Enclosure 11. Due to 21 being flexible, Synchronous Belt Guides(s) 52 are integrated into both 13 and 11. With 52 on both sides of 21, they are in a position to effectively transfer the rotational force to a linear one in the correct vertical plane, thus moving 42 to the desired position. The lateral constraints on 21, which keep the line of force in the proper axial location are done by the front wall of 13 and the inside wall of 11.

When 42 (see FIG. 4 and FIG. 6B) is extended, the Extended Position Limit Switch 78, mounted through 13, and is activated by 41 stopping 70. When the Mirror Housing 42 returns, the rotation of 70 and 22 is reversed and 21, pulling 28 to a position where the Retracted Position Limit Switch 77, mounted through 13, and is activated by 28 stopping the rotation. During the retraction, 52 closest to the unattached end of 21, prevents it from not remaining flat.

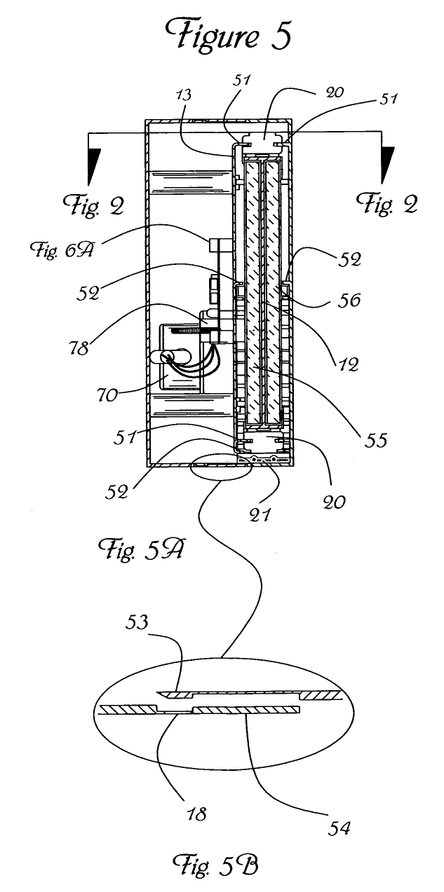

The design configuration is such that the mechanical sub-assemblies can be assembled and disassembled quickly with only simple tools. The first of these sub-assembles would consist of 10, 14, and 15 (see FIG. 1). The Motor 70 is fastened to 13 (see FIG. 1) with 77, 78, and FIG. 6A. (see FIG. 4), then 22 (see FIG. 2) would be attached to the Motor shaft. This sub-assembly would mount on the Mounting Plate Stand Off Tip(s) 19 (see FIG. 2). The Mirror Housing Assembly 42 (see FIG. 4) would be fitted between the appropriate Synchronous Belt Guide(s) 52 and on 51 with 21 being wrapped around 22 (see FIG. 2). Finally the Front Enclosure 11 is located by the Front Enclosure Locating Tab 53 engaging in the Rear Enclosure Locating Pocket 54 (see FIG. 5B) and pushing them together until they are snapped together (see FIG. 5A). To remove 11, press on 53, through the Enclosure Release Access Hole 18 (see FIG. 1), on the top and bottom, until it disengages from 54 and 10 and 11 can be separated.

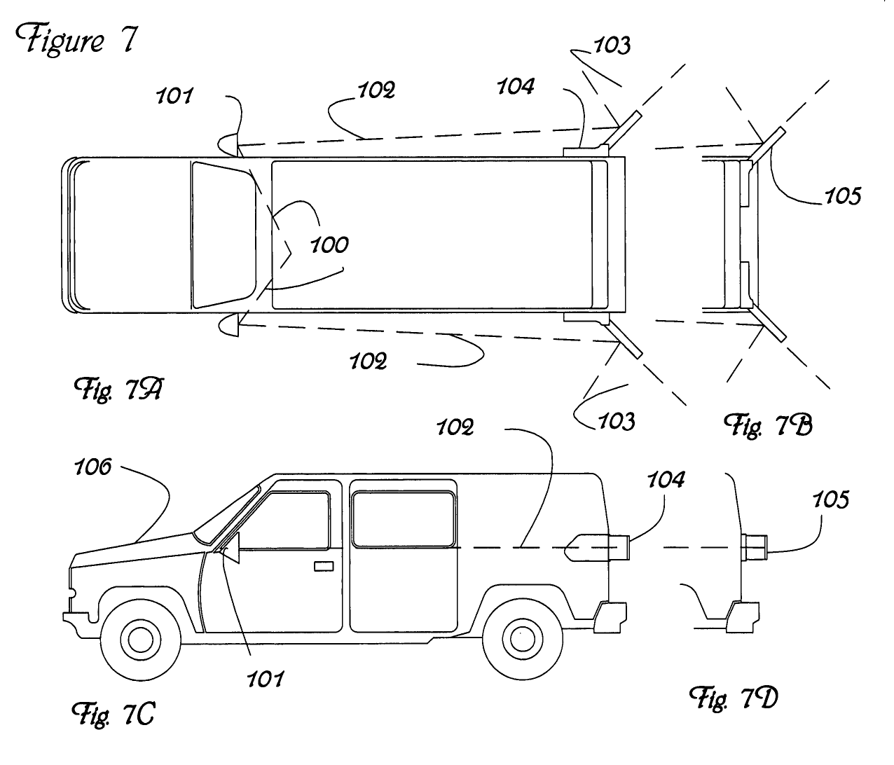

The way that this invention is positioned on the Vehicle 106 (see FIG. 7), is by mounting the outside wall of 10 on the outer surface of either the side or rear surface. This is by using the Unit Mounting Holes 16. The wire is introduced through the mounting surface of 10 by the Wire Access Hole 17.

The units are to be used as pairs where one is a mirror image of the other. The location whether on the side 104 or rear 105, must be in the same vertical plane as the Side Mirror 101. The position of the invention on the vehicle determines where the Mirror 50 (see FIG. 3), is assembled in 12, either in the Mirror Position For Rear Mount 55 or Mirror Position For Side Mount 56 (see FIG. 5A).

The driver uses the invention by viewing 101, using the Driver Sightline To Side Mirror 100, the Side Mirror To Invention Sightline 102, which gives a Field Of View 103 of the desired area 103 is available for both sides of 106.

To insure the greatest quality of image, 50 should have a minimum size of 5 inches (127 mm)×7 inches (178 mm) and be a First Surface Mirror.

While a preferred embodiment is described, many variations are apparent in, construction, component choices, and configuration.

I claim:

1. An extensible, pivoting mirror apparatus for a vehicle comprising longitudinally moving mirror housing on a fixed track,
a mirror housing containing the mirror, cam follower, and hardware, moveable longitudinally,
a torsion spring that pivots the mirror housing when in position,
a stationary bracket and mounting hardware, incorporating belt guides and bearing tracks,
a re-enforced synchronous timing belt, supported by the belt guides, that move the mirror housing,
an electric motor mounted to the bracket,
a synchronous pulley connected to said motor using the belt to extend or retract the mirror housing along the fixed track created by the bearing tracks,
a control module and limit switches are mounted to the fixed bracket,

2. The apparatus of claim 1, which further comprises bearings for longitudinal and pivoting motions with the longitudinal bearings connected.

3. The apparatus of claim 1, is contained in an enclosed housing which is composed of two parts.
the inside surface of the front portion of the enclosure is the cam surface
access for wiring is through the back wall of the rear portion of the enclosure

4. The apparatus of claim 3, is mounted on the exterior of the vehicle.
the apparatus is mounted in-line with the side mirror
the vehicle surface used to mount on can be either the side at the rear or on the rear

5. The apparatus of claim 1, is integrated into the vehicles electrical system.

6. The apparatus of claim 5, has a switch located in the drivers location for manual operation.

7. The apparatus of claim 1, when extended and pivoted allows a field of view perpendicular to the longitudinal axis of the vehicle.

8. The apparatus of claim 1, can use a mirror that gives a true view, a magnified view, or a expanded view.
